(19) United States
(12) Patent Application Publication
(10) Pub. No.: US 2023/0048987 A1
(43) Pub. Date: Feb. 16, 2023

(54) BLOW-MOLDING MACHINE WITH PRESSURE CONTROL DURING THE BLOW-MOLDING PROCESS

(71) Applicant: KRONES AG, Neutraubling (DE)

(72) Inventors: Thomas HOELLRIEGEL, Neutraubling (DE); Benedikt HENGL, Neutraubling (DE); Christian BETZ, Neutraubling (DE); Andreas BRUNNER, Neutraubling (DE)

(21) Appl. No.: 17/885,411

(22) Filed: Aug. 10, 2022

(30) Foreign Application Priority Data
Aug. 10, 2021 (DE) 10 2021 120 750.9

(51) Int. Cl. B29C 49/78; B29C 49/28; B29C 49/00

(52) U.S. Cl. CPC B29C 49/783; B29C 49/28; B29C 49/006; B29L 2031/7158

(57) ABSTRACT

A device for forming plastic parisons into plastic containers includes at least one forming station arranged on a conveying device and configured to form plastic parisons into plastic containers by applying a gaseous medium, the forming station includes an application device configured to apply the flowable medium to the plastic parisons, and includes a pressure supply device and/or is in fluidic connection with a pressure supply device configured to provide the flowable medium at a prespecified pressure, wherein pressure provided by the pressure supply device is greater than pressure required and/or used for the application to the plastic parisons, wherein the device includes at least one valve device which controls application to the plastic parisons, which valve device is configured to interrupt the supply of air into the container when the pressure of the flowable medium within the container has reached a prespecified pressure level.

### BACKGROUND OF THE INVENTION

The present document relates to a device and a method for forming plastic parisons into plastic containers. Such devices and methods have long been known from the prior art. Plastic parisons are usually placed in blow molds and expanded by means of a flowable and in particular a gaseous medium.

For this purpose, it is usual for a plurality of consecutive different pressures to be applied to the plastic parison in order to form the same into the plastic container, such as a plastic bottle, for example.

In the prior art, the required pressures (P1, Pi, P2) are provided in the blow-molding machine by mandrel pressure regulators. These pressure regulators are generally pilot-controlled by proportional valves in order to enable the operator to adjust the blowing pressures quickly and easily. In addition, these pressures can also be generated and supplied from outside the blowing wheel, for example in the stationary part of the machine, or even entirely outside the machine.

Here, these required blowing pressures must be supplied to the blowing wheel via a rotary medium distributor. However, this requires appropriate line cross-sections or causes a greater pressure loss due to the higher volume flow.

In the prior art, the mandrel pressure regulators, including the required attachments (as a whole also referred to as reducing station), are usually installed in the upper region of a rotating carousel of a blow-molding machine. These assemblies complicate access to a region of the device, for example a carousel. Due to their mass, reducing stations continue to have a negative influence on the center of mass as well as on the drive and braking torque of the carousel. Depending on the design, the cost of reducing stations lies between €1000 and €2500.

The blowing pressure required in each case is fed via these reducing stations to the plastic parison that is to be blown. At the beginning of the respective pressure phase, when the blowing valve is opened, a relatively large amount of air flows into the bottle, since the pressure difference between the respective pressure stage and the pressure in the bottle is relatively large. The closer the pressure in the container comes to the required pressure (e.g., P2), the longer it takes before the final pressure is reached or until the pressures have equalized.

The pressure rise per unit of time therefore decreases, the closer the pressure in the container approaches this pressure. In the prior art, a lot of time is lost in this way.

The present invention is therefore based on the object of eliminating at least partially the said reducing stations since they make the construction of the device more difficult. In addition, the invention is based on the object of achieving a faster expansion of the plastic containers and/or of the already formed plastic bottles.

### SUMMARY OF THE INVENTION

These objects are achieved according to the invention by a device and a method according to the independent claims. Advantageous embodiments and developments are the subject matter of the dependent claims.

A device according to the invention for forming plastic parisons into plastic containers and in particular into plastic bottles has a conveying device which is suitable and intended for conveying the plastic parisons along a prespecified conveying path. On this conveying device is arranged at least one forming station (or forming device), which is suitable and intended for reshaping the plastic parisons by applying a flowable and in particular gaseous medium in accordance with the plastic conditions.

In addition, the forming station has an application device which applies the flowable (and in particular gaseous) medium to the plastic parisons, wherein the device also has a pressure supply device and/or is connected to a pressure supply device which is suitable and intended to provide the application device with the flowable medium at a prespecified pressure.

In addition, the pressure provided by the pressure supply device is higher than the pressure required and/or used for the application to the plastic parisons.

According to the invention, the device has at least one valve device which controls and/or regulates the application (of the flowable and in particular gaseous medium) to the plastic parisons, wherein this valve device is designed in such a way that it interrupts the supply of the flowable and in particular gaseous medium (in particular air) into and/or onto the container when the pressure of the flowable medium within the container has reached a prespecified pressure level.

In the context of the invention, it is therefore proposed that the incoming pressure, which can, for example, come from a pressure connection or also from a compressor, is not reduced, but instead a valve causes the pressure supply to the container to be stopped when a prespecified pressure level has been reached.

Preferably, no pressure reduction device is provided in the flow path between the pressure supply device and the valve device and/or in the flow path between the pressure supply device and a compressed-air reservoir.

The idea of the invention is therefore to use the corresponding valves and fast valves described in detail below in order to stop filing the containers with compressed air once a certain pressure has been reached.

As mentioned above, the flowable medium is a gaseous medium and in particular compressed air.

Particularly preferably, the forming station has a blow mold. This blow mold is preferably formed in at least two parts, preferably three parts, and preferably has two side parts and a bottom part, which together form the cavity within which the plastic parisons are formed into the plastic containers and in particular bottles.

In a further preferred embodiment, the forming station has a rod-like body and in particular a so-called stretching rod, which is inserted into the containers in order to stretch said containers in their longitudinal direction.

Particularly preferably, the device has a plurality of such forming stations. These can preferably be arranged on the conveying device, which is in particular a blowing wheel.

Advantageously, the prespecified conveying path is a circular or circle-segment-shaped conveying path. Particularly preferably, the conveying device has a rotatable carrier on which the forming stations are arranged.

In a further preferred embodiment, the application device is a blowing nozzle which is applied to the plastic parison and in particular to an opening of the plastic parison in order to expand the plastic parison.

Preferably, the forming station(s) has or have (in each case) at least one valve block, into which a plurality of valves is integrated which carry out the switching of the different pressures or the application of different pressures to the plastic parisons. Preferably, this valve block has blowing valves with very short and/or reproducible switching times. In this way, it is possible to let compressed air flow in a targeted manner from a higher pressure level into the container, and to close the valve in good time when a predetermined pressure level in the container has been reached.

It is possible here for the pressure level in the container to be determined by the length of time the blowing valve or the valve device is open and gas and in particular compressed air is flowing into the container through the predetermined valve cross-sections.

A time control of the valve device would therefore also be conceivable.

Angle specifications are well suited as setting parameters for the operator since they are entered as integers or with a maximum of one decimal point. A switching time can then be calculated by the controller from the rotational speed of the carousel and the angle.

It should be noted that the present application refers to both plastic parisons and plastic containers. This is due to the fact that the plastic parisons are formed by the method described here into plastic containers and in particular into plastic bottles, and therefore transition situations are also present in which the plastic parison is already partially expanded but not yet fully formed into a bottle.

In a preferred embodiment, the device has at least one pressure detection device which determines or detects a pressure in the plastic parisons to be expanded or in the plastic containers to be produced. Here, the pressure detection device or pressure measuring device may also be integrated into the valve block mentioned.

Preferably, therefore, a pressure increase is thus determined by the pressure valve(s) used in the blow-molding machine, in particular by a corresponding blowing pressure recording. Each forming station can have an integrated pressure sensor or a pressure detection device.

By early closing of the respective blowing valve or valve device, the desired pressure is generated in the container. In this way, no separate pressure level is required in the components required therefor nor a reducing station, but it can be supplied or blown at the maximum available pressure (e.g., by a customer's compressed-air network or a compressor).

In this way, the container is filled significantly faster at the desired pressure since there is a greater pressure difference between the pressure being established and the pressure level desired. That is, there is only a wait until the required pressure, for example a pressure P2, has been set.

However, since a large amount of air (air mass flow) flows into the container due to the greater pressure difference, the blowing valves should be very fast, i.e., have very short switching times.

In a particularly preferred embodiment, the valve device has a switching time that is less than 40 ms, preferably less than 30 ms, preferably less than 25 ms, preferably less than 20 ms and particularly preferably less than 15 ms.

The valve device can be a hydraulically, electrically or particularly preferably a pneumatically operated valve device.

In a particularly preferred embodiment, the valve device is selected from a group of valve devices which comprises pneumatic valves, in particular pneumatically pilot-controlled and/or electrically actuated pneumatic valves, electrically controlled pneumatic valves, hydraulic valves, in particular pneumatically and/or electrically pilot-controlled hydraulic valves, solenoid valves and the like.

Due to the very short switching times, the required blowing pressure (for example a P2 pressure in the container) can be achieved largely accurately. The shorter the switching time of the valve device, the more accurately the required pressure can be achieved. In order, for example, to prevent an excessively rapid pressure increase in the case of very small containers (bottles), the flow path from the valve to the container can be narrowed by a choke (fixed or variable).

In a further preferred embodiment, the device has a pressure control device which is suitably intended to apply a plurality of different pressure stages to the plastic parison(s). It is thus possible for the plastic parison to be subjected initially to a pre-blowing pressure, then to an intermediate blowing pressure, and subsequently to a final blowing pressure. Further pressure stages can also be added.

Particularly preferably, at least one valve device of the type described above is connected between the highest pressure stage and the application device.

In a further advantageous embodiment, the device has at least one pressure reservoir or pressure accumulator and preferably a plurality of pressure reservoirs or pressure accumulators in which the flowable medium can be stored under different pressures. This pressure reservoir is preferably arranged on or at the conveying device and moves with and, in particular, therefore rotates with the conveying device.

Preferably, the pressure reservoir is an (in particular tubular) channel, in particular an annular channel which is suitable for holding the pressurized medium. Preferably, this at least one annular channel is therefore designed and set up to supply compressed air to a plurality of forming stations. For this purpose, the pressure reservoir with valve devices such as a valve block can be fluidically connected and/or can be brought into fluidic connection with the various forming stations.

In the case of a further advantageous embodiment, the device has a pressure generation or pressure supply device, which is in particular arranged in a stationary manner and which generates the pressurized medium and particularly preferably has a distribution device which conducts the medium into a reservoir arranged on the conveying device.

The device and in particular the individual forming stations are preferably in fluidic connection (at least indirectly, i.e., via further devices) with a pressure reservoir, which is, for example, a compressor or a pressure connection of a company. Preferably, the distribution device is a rotary distributor which can distribute compressed air to the individual annular channels and/or to the forming stations.

The present invention is further aimed at a method for forming plastic parisons into plastic containers and in particular into plastic bottles, wherein a conveying device conveys the plastic parisons along a prespecified conveying path, and wherein, with at least one forming station and/or forming device arranged on this conveying device, the plastic parisons are formed into the plastic containers by being acted upon by a flowable and in particular gaseous medium.

Furthermore, the forming station has an application device which applies the flowable medium to the plastic parisons, wherein the device furthermore has a pressure supply device and/or is connected to a pressure supply device which provides the flowable medium at a prespecified pressure to the application devices, wherein the pressure provided by the pressure supply device is greater than the pressure required and/or used for application to the plastic parisons.

Additionally or alternatively, it would also be possible for the forming stations to be in fluidic connection or be bringable into fluidic connection to the said pressure supply device. It is thus possible that the pressure supply device, like for example a compressor, is a component of the device, or else only a fluidic connection to a corresponding pressure supply device can be established.

According to the invention, the device has at least one valve device which controls the application of the flowable medium to the plastic parisons, wherein this valve device interrupts the supply of the flowable medium into the container when the pressure of the liquid medium within the container has reached a prespecified pressure level.

It is therefore also proposed that on the process side as well, the plastic parison or the container is acted upon by means of a pressure supply device which provides a pressure which is in fact a higher pressure than is necessary for the containers or their expansion.

However, by means of a valve or the valve device, the supply of compressed air is interrupted when a desired pressure level is reached. Preferably, the valve device is switched with a switching time of less than 30 ms, preferably less than 25 ms, preferably less than 20 ms, preferably less than 15 ms.

Particularly preferably, a flow rate and/or a flow rate of the liquid medium between the pressure supply device and the application device is determined. Preferably, the valve device is controlled and/or operated and/or regulated taking into account the (internal) pressure and/or the flow rate.

In a further preferred method, the plastic parison and/or the plastic container is subjected to a plurality of pressure stages, such as a pre-blowing pressure, an intermediate blowing pressure and a final blowing pressure. Preferably, the pressures increase as the time of application increases, i.e., the intermediate blowing pressure is preferably greater than the pre-blowing pressure and the final blowing pressure is preferably greater than the intermediate blowing pressure.

In a further preferred method, an internal pressure is measured at least from time to time in the plastic parison and/or plastic container to be expanded and/or a flow of the flowable medium flowing into the plastic parison is detected.

Particularly preferably a recording of a blowing pressure is made. This recording can be made in particular during the period in which the plastic parison is being shaped.

Preferably, the valve device is controlled taking into account the internal pressure. In this case, it is possible for a plurality of valve devices to be provided which control the application of a plurality of pressure stages to the plastic parison or plastic container. In this case, a plurality of these valve devices can also be controlled taking into account the (instantaneous) internal pressure.

In a further preferred method, the plastic parison and/or the plastic container are subjected to a plurality of pressure stages. Particularly preferably, the plastic parison is initially subjected to a pre-blowing pressure, then to an intermediate blowing pressure, which is preferably higher than the pre-blowing pressure, and finally to a final blowing pressure, which serves the complete shaping of the plastic container to the blow mold.

The switching of the valve device described here is carried out in particular at the highest pressure stage. However, it would also be possible for corresponding (fast-switching) valve devices to also be used for at least one further pressure stage and preferably for several further pressure stages.

In a further preferred method, the pressure profile is measured within a period in which a closure of the valve device takes place and the presence of leakages is preferably deduced from this pressure profile. If, for example, after the closure of a certain valve device—for example, a P2 valve, which serves for the final blow molding—the pressure changes and if this pressure changes in particular slightly upward, this can indicate a leak (in the valve device).

If the opening time of a valve device changes over the operating time compared to other forming stations (or the valve devices thereof), the device can preferably detect this and, in particular, automatically detect this, and preferably request preventive maintenance of this valve device.

Overall, a cost saving can be achieved due to the invention and both one or even a plurality of reducing devices can be saved. In addition, the invention makes it possible to save weight, which in turn has positive effects on the drive and braking torques of the conveying device or of a blowing wheel. In addition, the inner region of the device is also more easily accessible. Finally, the maintenance effort can also be reduced, in particular the maintenance of the mandrel, and a replacement of proportional valves can also be dispensed with.

In a preferred method, the opening time of a valve or a valve device is determined. In particular, the opening time is determined in order to shut off an effect of the valve device on the pressure profile (in particular in the interior of the container to be expanded).

In a further preferred method, the plastic parisons are expanded with a plurality of forming stations and these forming stations in each case have valve devices which control application to the plastic parisons. These valve devices interrupt the supply of air into the container when a pressure of the medium within the container has reached a prespecified pressure level.

In a further preferred method, a plurality of forming stations or forming devices are supplied by the same reservoir. As mentioned above, a plurality of reservoirs, in particular in the form of annular channels, can also be provided and/or be connected to a plurality of forming stations.

### BRIEF DESCRIPTION OF THE DRAWINGS

Further distribute embodiments emerge from the accompanying drawings: These show:

FIG. 1 a diagram of a device according to the internal prior art; and

FIG. 2 a diagram of a device according to the invention.

### DETAILED DESCRIPTION OF THE INVENTION

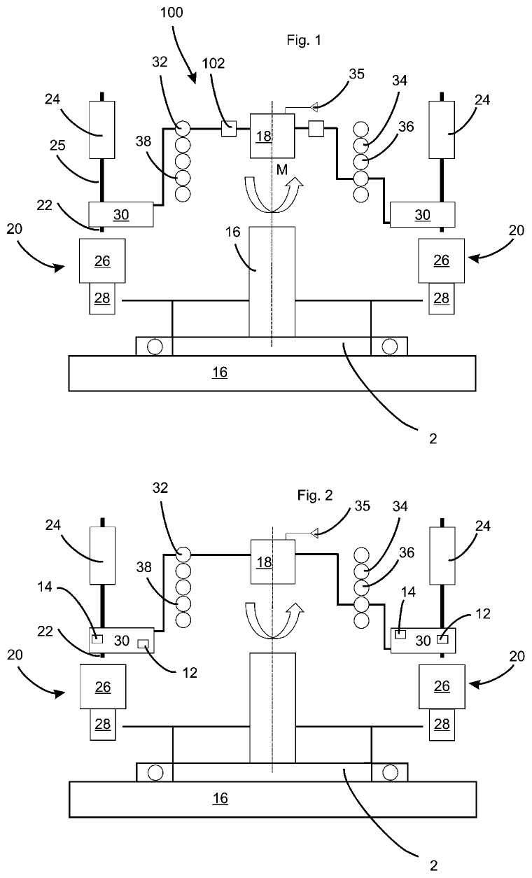

FIG. 1 shows a schematic representation of a device 100 according to the internal prior art of the applicant. In this case, a schematically illustrated conveying device is provided, which is denoted by the reference sign 2 and on which a plurality of forming stations 20 is arranged.

These forming stations 20 each have side parts 26 and a base part 28, which together form a cavity (not shown) within which the plastic parisons (not shown) are blown to form the containers. The conveying device is here (just as in the case of the invention) a carrier rotatable about an axis of rotation M.

The reference number 22 designates an application device which is here brought up to an opening in the plastic parison in order to apply compressed air to the latter. The reference number 30 designates a valve block which has a plurality of valves in order to supply the compressed air to the plastic parisons in different pressure stages.

The reference sign 24 designates a drive for a stretching rod 25 which is inserted into the plastic parison in order to serve the latter in its longitudinal direction.

In the prior art, the compressed air is distributed via a central air supply and a rotary distributor 18 to a plurality of annular channels, 32, 34, 36 and 38. The reference number 102 designates a reducing device which reduces the supplied pressure in order to supply, for example, the annular channel 32. According to the prior art, the compressed air is thus present in the annular channel to the required extent or at the required pressure. The reference number 16 designates a carrier of the device.

FIG. 2 schematically shows a device according to the invention. It can be seen that the reducing stations 102 are missing here, i.e., the ring channel 32 is supplied at a greater pressure than is actually required for expanding the plastic parisons. However, the valve block 30 here has at least one fast-switching valve or a fast-switching valve device 12, which causes the corresponding valve device to be closed (or the air supply via this valve device to be interrupted when a certain pressure is present within the container). For this purpose, internal pressure in the container is determined (in particular continuously) by means of a measuring device 14.

The reference sign 35 designates a pressure supply device. This can be, for example, a compressor (in particular arranged stationary) or else a pressure outlet in a machine hall.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A device for forming plastic parisons into plastic containers and in particular into plastic bottles, having a conveying device which is configured for conveying the plastic parisons along a prespecified conveying path, wherein at least one forming station is arranged on this conveying device and is configured to form the plastic parisons into the plastic containers by applying a gaseous medium, wherein the forming station comprises an application device configured to apply the flowable medium to the plastic parisons, wherein the device also comprises a pressure supply device and/or is in fluidic connection with a pressure supply device, which is configured to provide the flowable medium to the application device at a prespecified pressure, wherein the pressure provided by the pressure supply device is greater than the pressure required and/or used for the application to the plastic parisons,
wherein
the device comprises at least one valve device configured to control the application to the plastic parisons, wherein this valve device is configured to interrupt the supply of air into the container when the pressure of the flowable medium within the container has reached a prespecified pressure level.

2. The device according to claim 1,
wherein
the device comprises at least one pressure detection device configured to determines a pressure in the plastic parison that is to be expanded.

3. The device according to claim 1,
wherein
the valve device has a switching time that is less than 40 ms, preferably less than 30 ms, preferably less than 25 ms, preferably less than 20 ms and particularly preferably less than 15 ms.

4. The device according to claim 1,
wherein
the device comprises a pressure control device which is configured to apply a plurality of different pressure stages to the plastic parison.

5. The device according to claim 1,
wherein
the device comprises at least one pressure reservoir and preferably a plurality of pressure reservoirs in which the flowable medium can be stored under different pressures.

6. The device according to claim 1,
wherein
the device comprises a pressure supply device, which is arranged in particular in a stationary manner and generates the pressurized medium, and preferably a distribution device, which conducts the medium into a reservoir arranged on the conveying device.

7. A method for forming plastic parisons into plastic containers and in particular into plastic bottles, wherein a conveying device, which conveys the plastic parisons along a prespecified conveying path, and wherein with a forming station arranged on this conveying device, the plastic parisons are formed into the plastic containers by application of a gaseous medium, wherein the forming station comprises an application device which applies the flowable medium to the plastic parisons, wherein the device also comprises a pressure supply device and/or is in fluidic connection with a pressure supply device, which provides the flowable medium at a prespecified pressure to the application device, wherein the pressure provided by the pressure supply device is greater than the pressure required and/or used for the application to the plastic parisons,
wherein
the device comprises at least one valve device which controls the application to the plastic parisons, wherein this valve device interrupts the supply of air into the plastic container when the pressure of the flowable medium within the plastic container has reached a prespecified pressure level.

8. The method according to claim 7,
wherein
at least from time to time, an internal pressure in the plastic parison or plastic container that is to be expanded and/or a flow of the flowable medium flowing into the plastic parison is measured.

9. The method according to claim 7,
wherein
the valve device is controlled taking into account the internal pressure.

10. The method according to claim 7,
wherein
a plurality of pressure stages is applied to the plastic parison and/or the plastic container.

11. The method according to claim 7,
wherein
a pressure profile is measured within a period in which a closure of the valve device takes place and the presence of leakages is preferably deduced from this pressure profile.

12. The method according to claim 7,
wherein
an opening time of the valve device is determined.

13. The method according to claim 7,
wherein
the plastic parisons are expanded with a plurality of forming stations and these forming stations in each case comprise valve devices which control the application to the plastic parisons, wherein these valve devices interrupt the supply of air into the container when the pressure of the flowable medium within the container has reached a prespecified pressure level.
